(19) United States
(12) Patent Application Publication
(10) Pub. No.: US 2025/0306167 A1
(43) Pub. Date: Oct. 2, 2025

(54) METHOD AND SYSTEM FOR MULTI-CHIP OPERATION OF RADAR SYSTEMS

(71) Applicant: Robert Bosch Gmbh, Gerlingen (DE)

(72) Inventors: Monier Maher, St. Louis, MO (US); Arunesh Roy, San Jose, CA (US); Murtaza Ali, Cedar Park, TX (US); Jean Pierre Bordes, St. Charles, MO (US); Curtis Davis, St. Louis, MO (US)

(21) Appl. No.: 19/238,678

(22) Filed: Jun. 16, 2025

Related U.S. Application Data
(63) Continuation of application No. 18/439,191, filed on Feb. 12, 2024, now Pat. No. 12,332,376.
Application No. 18/439,191 is a continuation of application No. 17/147,960, filed on Jan. 13, 2021, now Pat. No. 11,899,126.
(60) Provisional application No. 62/960,220, filed on Jan. 13, 2020.

(51) Int. Cl. G01S 7/35; G01S 7/02; G01S 7/28; G01S 7/32; G01S 7/40; G01S 13/34; G01S 13/36; G01S 13/42; G01S 13/58; G01S 13/87; G01S 13/931; H01Q 3/26

(52) U.S. Cl. CPC G01S 7/352; G01S 7/023; G01S 7/4004; G01S 13/34; G01S 13/584; G01S 13/588; G01S 13/931; H01Q 3/267; G01S 7/28; G01S 7/32; G01S 7/356; G01S 13/36; G01S 13/42; G01S 13/878; G01S 2013/93271; G01S 2013/93272

(57) ABSTRACT

A multi-chip MIMO radar system includes respective pluralities of transmitters and receivers arranged on a plurality of circuit chips. The multi-chip MIMO radar system includes a processor that receives data from the plurality of circuit chips. Selected ones of the plurality of circuit chips generate sets of selected range, Doppler, and virtual receiver data. The processor processes the sets of selected range, Doppler, and virtual receiver data to produce selected range detection and angular resolvability of targets.

### CROSS REFERENCE TO RELATED APPLICATIONS

The present application is a continuation of U.S. patent application Ser. No. 18/439,191, filed Feb. 12, 2024, which is a continuation of U.S. patent application Ser. No. 17/147,960, filed Jan. 13, 2021, which claims the filing benefits of U.S. provisional application, Ser. No. 62/960,220, filed Jan. 13, 2020, which are all hereby incorporated by reference herein in their entireties.

### FIELD OF THE INVENTION

The present invention is directed to radar systems, and in particular to digital radar systems.

### BACKGROUND OF THE INVENTION

The use of radar to determine location and velocity of objects in an environment is important in a number of applications including, for example, automotive radar, industrial processes, and gesture detection. A radar system typically transmits radio signals and listens for the reflection of the radio signals from objects in the environment. By comparing the transmitted radio signals with the received radio signals, a radar system can determine the distance to an object, and the velocity of the object. Using multiple transmitters and/or receivers, or a movable transmitter or receiver, the location (angle) of an object can also be determined.

A radar system consists of transmitters and receivers. The transmitters generate a baseband signal, which is up-converted to a radio frequency (RF) signal that propagates according to an antenna pattern. The transmitted signal is reflected off of objects or targets in the environment. The received signal at each receiver is the totality of the reflected signal from all targets in the environment. The receiver down-converts the received signal to baseband and compares the baseband received signal to the baseband signal at one or more transmitters. This is used to determine the range, velocity, and angle of targets in the environment.

A MIMO radar system includes a plurality of transmitters and a plurality of receivers. Each of the plurality of transmitters is coupled to a corresponding antenna, and each of the plurality of receivers is coupled to a corresponding antenna. The transmitter and receiver antennas are used to form a first set of virtual antenna locations. The more virtual antennas the better the angular resolution.

### SUMMARY OF THE INVENTION

Methods and systems of the present invention provide for a radar using a plurality of radar chips (separate system-on-chip radars) so that they can be used together to improve performance and/or angular resolution (MIMO radar systems). In accordance with an embodiment of the present invention, the detection range (the range at which targets are detected) can be increased and the angular resolution (the minimum angle when two targets at the same range and Doppler can be separated) can be improved by increasing the number of transmitters or receivers or both in a radar system.

In one aspect of the present invention, multiple radar chips are connected to a centralized processing unit. Each radar chip is also connected to its own plurality of transmitter and receiver antennas. Each of the radar chips processes the data received on its receiver antennas to create a radar data cube for range, Doppler and virtual receiver. The virtual receiver information generated in each respective radar chip are based on all or a subset of the transmitters on all the radar chips. Each radar chip then passes their respective radar data cube information on a selected range and Doppler which are combined in the centralized processing unit to produce the final radar output in terms of range, Doppler, and angle (azimuth/elevation) of the detected targets.

In another aspect of the present invention, each of the radar chips are connected to multiple sets of transmitters and/or receivers via a switch. This allows Time Domain Multiplexing (TDM) operation across different transmit/receiver antenna sets connected to all the radar chips.

A multiple input, multiple output (MIMO) radar system on an integrated circuit chip in accordance with an embodiment of the present invention includes a plurality of circuit chips. A first plurality of transmitters and a first plurality of receivers are arranged on a first circuit chip of the plurality of circuit chips. A second plurality of transmitters and a second plurality of receivers are arranged on a second circuit chip of the plurality of circuit chips. The MIMO radar system includes a central processing unit configured to receive range, Doppler, and virtual receiver data from the first circuit chip and the second circuit chip. The first circuit chip and the second circuit chip are part of the integrated circuit chip.

A multiple input, multiple output (MIMO) radar system on an integrated circuit chip in accordance with an embodiment of the present invention includes a plurality of circuit chips, each configured as a radar chip. The plurality of circuit chips is part of the integrated circuit chip. A first circuit chip of the plurality of circuit chips comprises a first plurality of transmitters and a first plurality of receivers. A second circuit chip of the plurality of circuit chips comprises a second plurality of transmitters and a second plurality of receivers. The MIMO radar system includes a central processing unit configured to receive and process range, Doppler, and virtual receiver data from at least two circuit chips of the plurality of circuit chips.

In an aspect of the present invention, the transmitters and receivers of the circuit chips are coupled to respective antennas of an antenna array. The antenna array includes a receive antenna array and a transmit antenna array. Each antenna of the receive antenna array may have a same field of view defining an antenna directivity pattern. Each antenna of the transmit antenna array may have a same field of view defining an antenna directivity pattern.

In another aspect of the present invention, the central processing unit is operable to control the circuit chips.

In a further aspect of the present invention, the central processing unit is operable to request a subset of range, Doppler, and virtual receiver data collected and processed by at least two of the circuit chips of the plurality of circuit chips. The central processing unit is operable to combine the range, Doppler, and virtual receiver data received from the plurality of circuit chips. The central processing unit is operable to process the combined range, Doppler, and virtual receiver data.

In yet another aspect of the present invention, the central processing unit is operable to perform target detection and angle estimation for a target from the combined range, Doppler, and virtual receiver data. The central processing unit is also operable to perform angle estimation on the combined range, Doppler, and virtual receiver data using Fast Fourier Transform (FFT) on the virtual receiver data for a given range and Doppler.

### BRIEF DESCRIPTION OF THE DRAWINGS

FIG. 1 is a plan view of an automobile equipped with a radar system in accordance with the present invention;

FIGS. 2A and 2B are block diagrams of radar systems in accordance with the present invention;

FIG. 3 is a block diagram illustrating a radar system using a single chip with a plurality of receivers and a plurality of transmitters in accordance with the present invention;

FIG. 4 is a block diagram illustrating a radar system with multiple chips, each with a respective plurality of receivers and a plurality of transmitters of its own in accordance with the present invention;

FIG. 5 is a block diagram of a radar system with a plurality of radar chips each with a respective plurality of receivers and a plurality of transmitters of its own and connected to a centralized processor in accordance with the present invention;

FIG. 6 shows an exemplary structure of an antenna system in accordance with the present invention;

FIG. 7 is a block diagram of a radar system in FIG. 5 showing how the data is generated in each radar chip and then combined in the centralized processor in accordance with the present invention;

FIG. 8 shows part of the processing blocks for each radar chip to generate range and Doppler information across the virtual receivers in accordance with the present invention; and

FIG. 9 shows the rest of the processing blocks for each radar chip to generate the range and Doppler map to send to the centralized processor along with the corresponding sparsified range, Doppler, and virtual receiver data cube in accordance with the present invention.

### DESCRIPTION OF THE PREFERRED EMBODIMENTS

Referring to the drawings and the illustrative embodiments depicted therein, wherein numbered elements in the following written description correspond to like-numbered elements in the figures, an improved radar system utilizes multiple radar system-on-chips (“chip(s)”). A central processing unit of the radar system provides for the management a multi-chip MIMO radar system. The MIMO radar system includes a plurality of transmitters and a plurality of receivers on a plurality of radar chips. Each transmitter of the plurality of transmitters is coupled to a corresponding antenna, and each receiver of the plurality of receivers is coupled to a corresponding antenna. The transmitter and receiver antennas are used to form a set of virtual antenna locations (virtual receivers). The central processing unit is operable to control the plurality of radar chips, such that the plurality of radar chips may be adjusted to provide for at least one of virtual receiver scalability, range scalability, range bin scalability, and scalable angle performance.

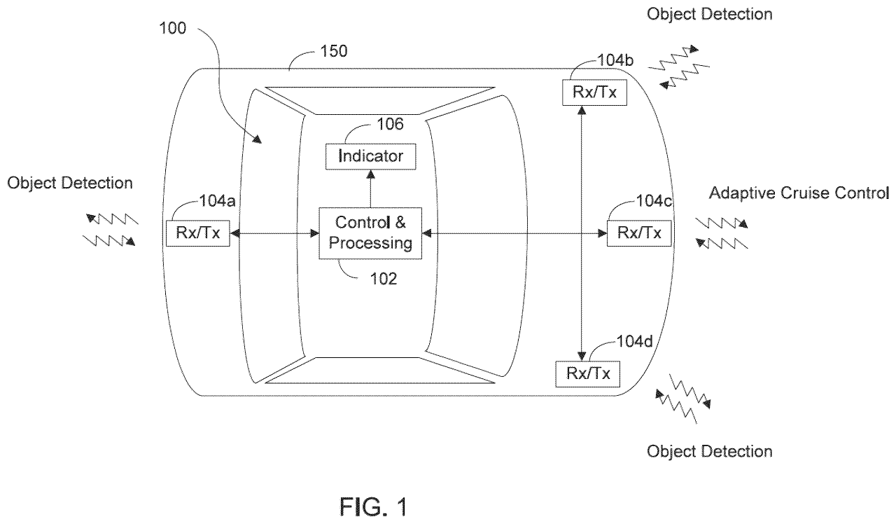

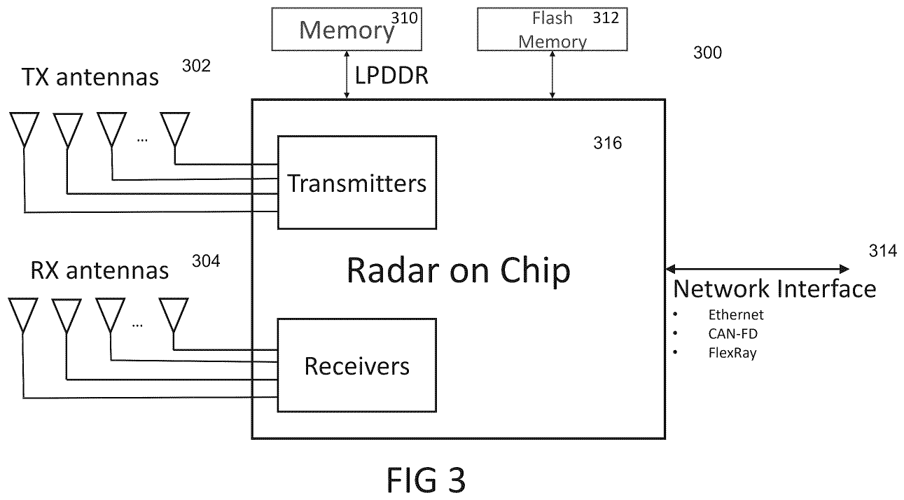

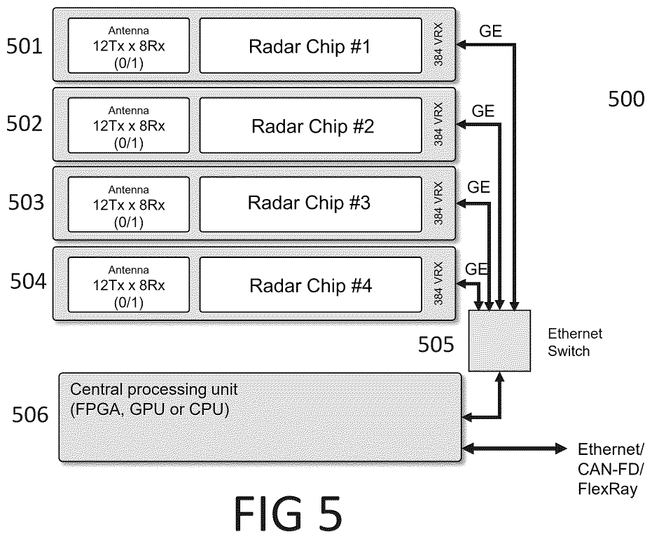

FIG. 1 illustrates an exemplary radar system 100 configured for use in a vehicle 150. An exemplary vehicle 150 may be an automobile, truck, or bus, etc. The radar system 100 may utilize multiple radar systems (e.g., 104a-104d) embedded in the vehicle 150 (see FIG. 1). Each of these radar systems may employ multiple radar chips each with multiple transmitters, receivers, and antennas (see FIGS. 3 and 5). The transmitters of the radar system 100 transmit radio signals that are reflected from objects (also known as targets) in the environment and received by one or more receivers of the radar system 100. A transmitter-receiver pair is called a virtual radar (or sometimes a virtual receiver). As illustrated in FIG. 1, the radar system 100 may comprise one or more transmitters and one or more receivers (104a-104d) for a plurality of virtual radars. Other configurations are also possible. FIG. 1 illustrates the receivers/transmitters 104a-104d placed to acquire and provide data for object detection and adaptive cruise control. As illustrated in FIG. 1, a controller 102 receives and then analyzes position information received from the receivers 104a-104d and forwards processed information (e.g., position information) to, for example, an indicator 106 or other similar devices, as well as to other automotive systems. The radar system 100 (providing such object detection and adaptive cruise control or the like) may be part of an Advanced Driver Assistance System (ADAS) for the automobile 150.

An exemplary radar system operates by transmitting one or more signals from one or more transmitters and then listening for reflections of those signals from objects in the environment by one or more receivers. By comparing the transmitted signals and the received signals, estimates of the range, velocity, and angle (azimuth and/or elevation) of the objects can be estimated.

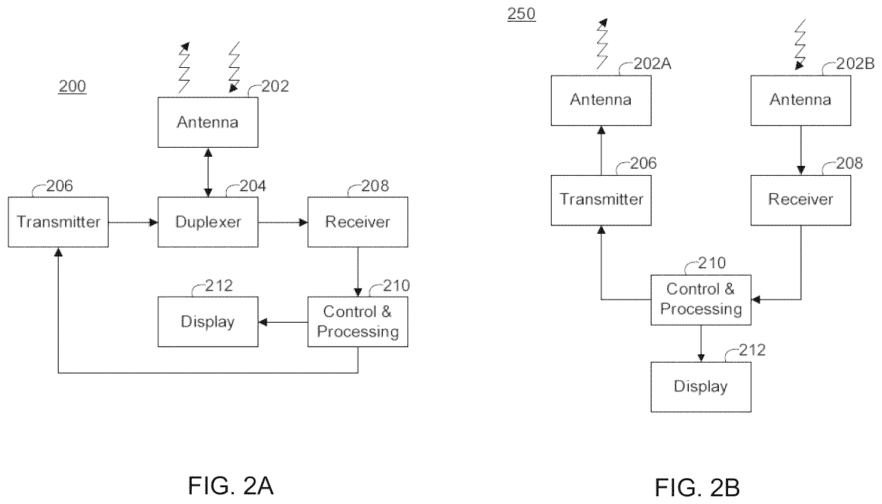

There are several ways to implement a radar system. One way, illustrated in FIG. 2A, uses a single antenna 202 for transmitting and receiving. The antenna 202 is connected to a duplexer 204 that routes the appropriate signal from the antenna 202 to a receiver 208 or routes the signal from a transmitter 206 to the antenna 202. A control processor 210 controls the operation of the transmitter 206 and the receiver 208 and estimates the range and velocity of objects in the environment. A second way to implement a radar system is shown in FIG. 2B. In this system, there are separate antennas for transmitting (202A) and receiving (202B). A control processor 210 performs the same basic functions as in FIG. 2A. In each case, there may be a display 212 to visualize the location of objects in the environment.

A radar system using a single chip with multiple antennas, transmitters, and receivers is shown in FIG. 3. Using multiple antennas 302, 304 allows an exemplary radar system 300 to determine the angle (azimuth or elevation or both) of targets in the environment. Depending on the geometry of the antenna system, different angles (e.g., azimuth or elevation) can be determined.

The radar system 300 may be connected to a network via an Ethernet connection or other types of network connections 314, such as, for example, CAN-FD and FlexRay. The radar system 300 may also have memory (310, 312) to store intermediate data and software used for processing the signals in order to determine range, velocity, and location of objects. Memory 310, 312 may also be used to store information about targets in the environment. There may also be processing capability contained in the application-specific integrated circuit (ASIC) 316 (henceforth called the “Radar on Chip” or simply “radar chip”) apart from the transmitters 302 and receivers 304.

The description herein includes an exemplary radar system in which there are N_{T} transmitters and N_{R} receivers for N_{T}×N_{R} virtual radars, one for each transmitter-receiver pair. For example, a radar system with twelve transmitters and eight receivers will have 96 pairs or 96 virtual radars (with 96 virtual receivers). When three transmitters (Tx1, Tx2, Tx3) generate signals that are being received by three receivers (Rx1, Rx2, Rx3), each of the receivers is receiving the transmission from each of the transmitters reflected by objects in the environment (and thus, nine pairs or nine virtual radars).

There are several different types of signals that transmitters in radar systems employ. A radar system may transmit a pulsed signal or a continuous signal. In a pulsed radar system, the signal is transmitted for a short time and then no signal is transmitted. This is repeated over and over. When the signal is not being transmitted, the receiver listens for echoes or reflections from objects in the environment. Often a single antenna is used for both the transmitter and receiver and the radar transmits on the antenna and then listens to the received signal on the same antenna. This process is then repeated. In a continuous wave radar system, the signal is continuously transmitted. There may be an antenna for transmitting and a separate antenna for receiving.

Another classification of radar systems is the modulation of signal being transmitted. A first type of continuous wave radar signal is known as a frequency modulated continuous wave (FMCW) radar signal. In an FMCW radar system, the transmitted signal is a sinusoidal signal with a varying frequency. By measuring a time difference between when a certain frequency was transmitted and when the received signal contained that frequency, the range to an object can be determined. By measuring several different time differences between a transmitted signal and a received signal, velocity information can be obtained.

A second type of continuous wave signal used in radar systems is known as a phase modulated continuous wave (PMCW) radar signal. In a PMCW radar system, the transmitted signal from a single transmitter is a sinusoidal signal in which the phase of the sinusoidal signal varies. Typically, the phase during a given time period (called a chip period or chip duration) is one of a finite number of possible phases. A spreading code consisting of a sequence of chips, (e.g., +1, +1, −1, +1, −1 . . . ) is mapped (e.g., +1→0, −1→p) into a sequence of phases (e.g., 0, 0, p, 0, p . . . ) that is used to modulate a carrier to generate the radio frequency (RF) signal. The spreading code could be a periodic sequence or could be a pseudo-random sequence with a very large period, so it appears to be a nearly random sequence. The spreading code could be a binary code (e.g., +1 or −1). The resulting signal has a bandwidth that is proportional to the rate at which the phases change, called the chip rate f_{chip}, which is the inverse of the chip duration, T_{chip}=1/f_{chip}. In a PMCW radar system, the receiver typically performs correlations of the received signal with time-delayed versions of the transmitted signal and looks for peaks in the correlation as a function of the time-delay, also known as correlation lag. The correlation lag of the transmitted signal that yields a peak in the correlation corresponds to the delay of the transmitted signal when reflected off an object. The round-trip distance to the object is found by multiplying that delay (correlation lag) by the speed of light.

In some radar systems, the signal (e.g. a PMCW signal) is transmitted over a short time period (e.g. 1 microsecond) and then turned off for a similar time period. The receiver is only turned on during the time period where the transmitter is turned off. In this approach, reflections of the transmitted signal from very close targets will not be completely available because the receiver is not active during a large fraction of the time when the reflected signals are being received. This is called pulse mode.

Digital frequency modulated continuous wave (FMCW) and phase modulated continuous wave (PMCW) are techniques in which a carrier signal is frequency or phase modulated, respectively, with digital codes using, for example, GMSK. Digital FMCW/PMCW radar lends itself to be constructed in a MIMO variant in which multiple transmitters transmitting multiple codes are received by multiple receivers that decode all codes. The advantage of the MIMO digital FMCW/PMCW radar is that the angular resolution is that of a virtual antenna array having an equivalent number of elements equal to the product of the number of transmitters and the number of receivers. Digital FMCW/PMCW MIMO radar techniques are described in U.S. Pat. Nos. 9,989,627; 9,945,935; 9,846,228; and 9,791,551, which are all hereby incorporated by reference herein in their entireties.

Embodiments of the radar sensing system may utilize aspects of the radar systems described in U.S. Pat. Nos. 10,261,179; 9,971,020; 9,954,955; 9,945,935; 9,869,762; 9,846,228; 9,806,914; 9,791,564; 9,791,551; 9,772,397; 9,753,121; 9,689,967; 9,599,702; 9,575,160, and/or 9,689,967, and/or U.S. Publication Nos. US-2017-0309997; and/or U.S. patent applications, Ser. No. 16/674,543, filed Nov. 5, 2019, Ser. No. 16/259,474, filed Jan. 28, 2019, Ser. No. 16/220,121, filed Dec. 14, 2018, Ser. No. 15/496,038, filed Apr. 25, 2017, Ser. No. 15/689,273, filed Aug. 29, 2017, Ser. No. 15/893,021, filed Feb. 9, 2018, and/or Ser. No. 15/892,865, filed Feb. 9, 2018, and/or U.S. provisional application, Ser. No. 62/816,941, filed Mar. 12, 2019, which are all hereby incorporated by reference herein in their entireties.

### Multi-Chip Radar Systems

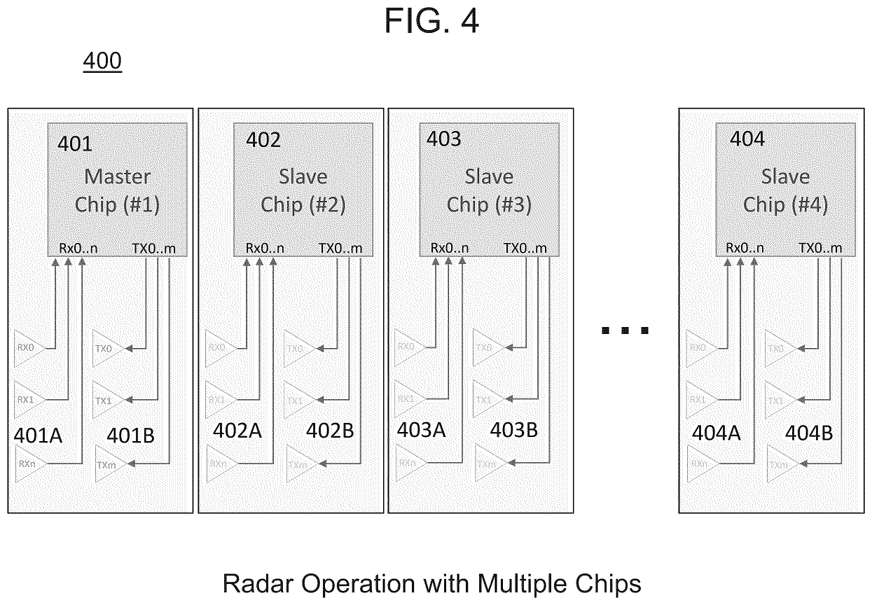

Embodiments discussed herein utilize an exemplary method for incorporating a plurality of radar chips or ASICs into a single radar system to improve detection range and angular resolution performance. FIG. 4 shows an exemplary radar system 400 using a plurality of radar chips 401, 402, 403, and 404 (which could also be described as 40n). One of the chips 401 is considered as master and the other chips 402, 403 and 404 are slaves. The (m+1) transmitters (numbered 0 . . . m) of each of the chips are connected to (m+1) individual antennas. For example, chip 401 is connected to (m+1) transmit antennas 401A, chip 402 is connected to transmit antennas 402A and so on. Similarly, the (n+1) receivers (numbered 0 . . . n) of each of the chips are connected to (n+1) individual antennas. For example, chip 401 is connected to (n+1) receive antennas 401B, chip 402 is connected to receive antennas 402B and so on. The plurality of radar chips 401, 402, 403, and 404 in the radar system 400 needs to be synchronized. Synchronization techniques across a plurality of radar chips are described in U.S. patent publication No. 2020/0292666, which is hereby incorporated by reference herein in its entirety.

We now describe the exemplary implementation illustrated in FIG. 5. The system 500 uses an exemplary four (4) radar chips 501, 502, 503, and 504 (each with their own antenna array) connected to a central processor 506. Each individual radar chip 501, 502, 503, and 504 with its own plurality of transmit and receive antennas constitutes a radar sub-system 501, 502, 503 and 504. As illustrated in FIG. 5 radar sub-system 501 uses radar chip #1, radar sub-system 502 radar chip #2 and so on. The radar chips 501, 502, 503, and 504 are connected to an Ethernet switch 505 using Gigabit Ethernet (GE). The switch 505 is connected to the central processing unit 506. The individual radar chip (501, 502, 503, and 504) thus communicates with the central processing unit 506 using Gigabit Ethernet via an Ethernet Switch 505. The output of the central processing unit 506 is available through Ethernet or CAN-FD or FlexRay depending on overall system configuration. FIG. 5 shows an exemplary case where each radar chip 501, 502, 503 and 504 is connected to two sets of RX antennas (each set containing 8 receive antennas) via 8 individual RF switches. The switches are incorporated inside the individual radar chips 501, 502, 503 and 504. The two sets are numbered 0/1 in FIG. 5.

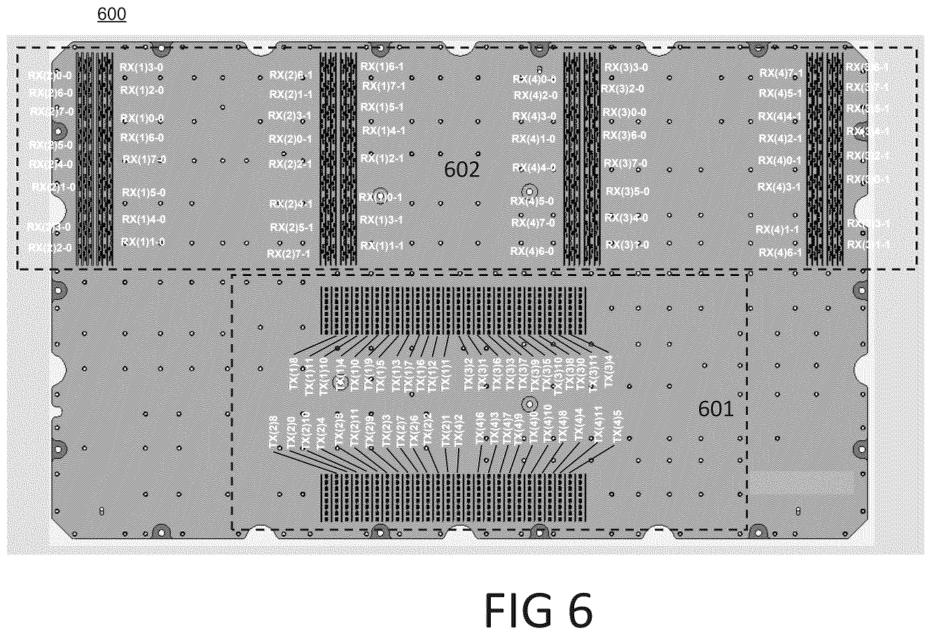

FIG. 6 shows the structure of an exemplary antenna array 600 that can be used by the radar system 500 in FIG. 5. Antenna array 601 constitutes the transmit antenna array. There are 4×12=48 transmit antennas (12 antennas per radar chip) in this exemplary implementation. The numbering TX(p)q indicates that it is the qth antenna (q=0,1, . . . 11) connected to the pth chip. Similarly, antenna array 602 constitutes the receive antenna array where the antenna numbered RX(p)q-r indicates that it is the qth antenna (q=0,1, . . . 7) connected to rth switch of the pth chip. There are a total of 2 (number of switches)×4 (number of chip)×8 (number of receivers per chip per switch)=64 receive antennas in this exemplary implementation.

If only one switch is used, we have 48 transmitters and 32 receivers providing the capability to have 1536 virtual receivers in such a system. If two switches are used as shown, the system is capable of 3072 virtual receivers. In the exemplary case where both the switches are used, the system switches to the first 1536 virtual receivers for a prescribed period of time and then switches to the second 1536 virtual receivers for a second prescribed period of time and then alternates between the two virtual receiver sets, staying on each for its prescribed period of time.

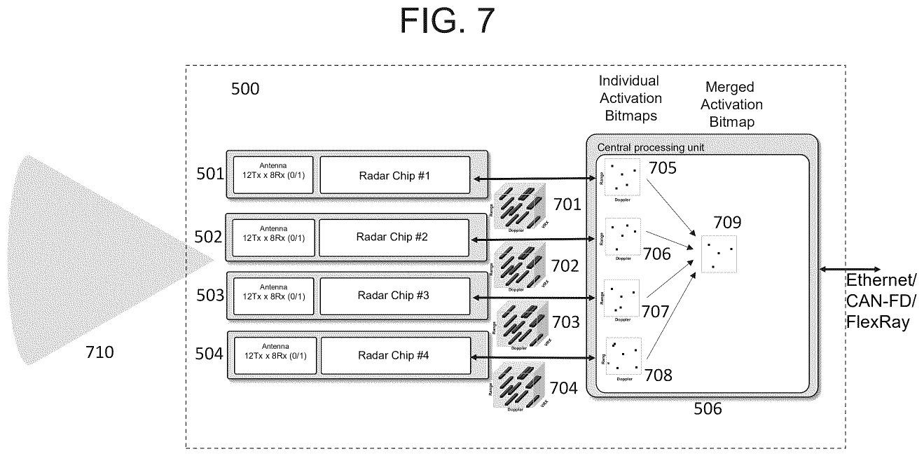

FIG. 7 gives another view of the system described in FIG. 5. FIG. 5 shows an exemplary Field of View (FoV) 710 of the radar systems 501, 502, 503 and 504. Each individual transmit antenna element in the transmit array in FIG. 6 should have the same FoV (or antenna directivity pattern). Similarly, individual receive antenna elements in the receive array in FIG. 6 should have the same FoV. This ensures that the all the virtual antenna elements in the array have the same FoV.

Each individual radar chip (501, 502, 503 and 504) functions as a sub-system whose purpose is to convert the signal arriving at the plurality of the receive antennas connected to the particular chip into range/Doppler data per virtual receivers comprising the receive antennas connected to the particular radar chip and all or a subset of the transmit antennas in the overall radar system 500. The individual chips 501, 502, 503 and 504 also select a subset of the range/Doppler data that it forwards to the central processing unit 506. The subset selection is known as activations. These activations are shown in dark colored skewers in the range/Doppler/virtual receiver (VRX) data cubes 701, 702, 703, and 704 in FIG. 7. A bit map (705, 706, 707, and 708) showing which range/Doppler data has been forwarded is also sent to the central processing unit 506. In the exemplary implementation in FIG. 7, sub-system 501 (radar chip #1 with its connected receive antenna) generates the activations 701 and bitmaps 705, sub-system 502 generates activations 702 and bitmap 706 and so on. This down-selection of range/Doppler also serves to reduce the bandwidth of data to be transferred between each individual radar chip 501, 502, 503 and 504 and the central processing unit 506. The central processing unit 506 combines the activation bit maps 705, 706, 707, and 708 into a single merged bit map 709 indicating the range/Doppler data that will be further processed in the central processing unit 506. The merging can simply be the intersection of the individual bitmaps (meaning the merged bit map will have valid values only if there is a valid value in all the individual bitmaps for a given range/Doppler). The central processing unit 506 then performs target detection as well as angle (azimuth/elevation) estimation for the target from the range, Doppler, and virtual receivers (across all radar chips 501, 502, 503 and 504 in the system 500)

In one exemplary implementation, angle estimation can be done using Fast Fourier Transform (FFT) on the virtual receiver data for a given range and Doppler. In another implementation, a sub-space based method like the well-known MUSIC (Multiple Signal Classification) can be used for angle estimation.

Target detection can be performed by a threshold test where values above a threshold are declared as targets. The threshold can be locally adjusted based on Constant False Alarm Rate (CFAR) criteria.

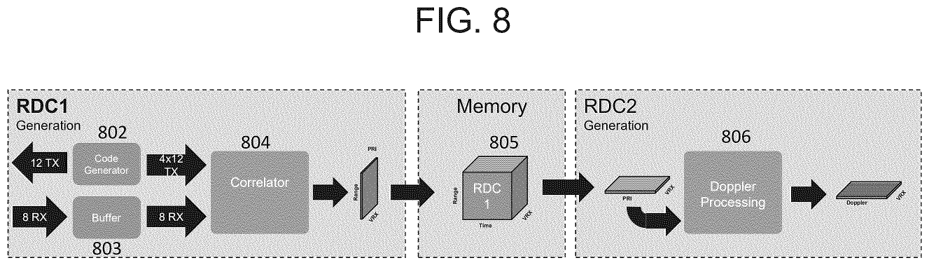

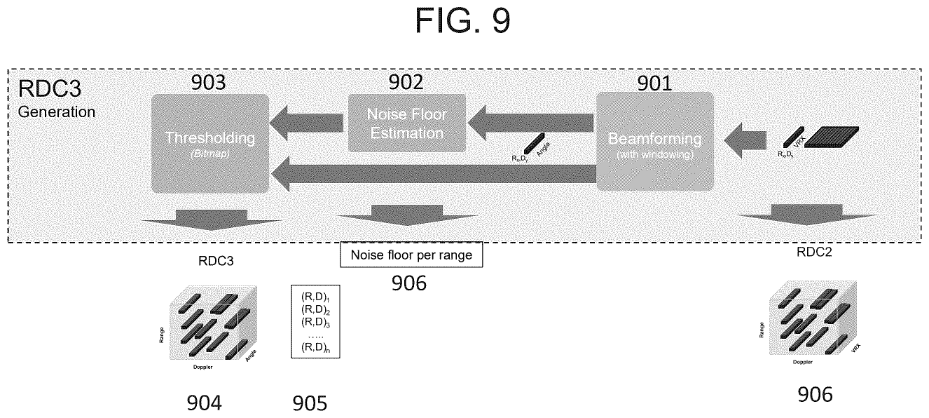

We now describe an exemplary method of creating the activations (701, 702, 703, and 704) and the corresponding bitmap (705, 706, 707, and 708) in each individual radar chip 501, 502, 503, and 504 with reference to FIGS. 8 and 9. FIG. 8 shows the method of converting the incoming data in the receivers for the given radar chip into range, Doppler and virtual receiver data. This data is often referred to as RDC2 (Radar Data Cube #2). As mentioned earlier, in an exemplary implementation, a corresponding spreading code (modulation) is transmitted by each transmitter. Different spreading codes are transmitted simultaneously on the different antennas. In the implementation shown in FIG. 5, each radar chip has 12 transmitters transmitting 12 different spreading codes. The multi-chip radar system has four (4) radar chips with a total of 48 transmitters transmitting 48 different spreading codes. The 48 codes are known to all of the radar chips 501, 502, 503 and 504, or can be generated in the code generator unit 802 inside each of the radar chips 501, 502, 503 and 504. Code generator 802 generates all the 48 codes (thus, each radar chip generates all 48 codes). Each radar chip (501, 502, 503, and 504) transmits its own 12 codes on the 12 transmitters connected to its own chip. The data from the 8 receivers (on the own chip) are collected into a buffer 803 and then forwarded to the correlator unit 804. The correlator unit 804 correlates each of the 8 receiver data with the 48 spreading codes thereby generating 48×8=384 virtual receiver data. The time spent for each correlation is known as a Pulse Repetition Interval (PRI). The correlator unit 804 converts the received data across its 8 receivers into range, PRI and virtual receiver data commonly referred to as RDC1 (Radar Data Cube #1) 805 is saved in memory. The RDC1 data is then converted into RDC2 data (a second radar data cube) using the Doppler processing unit 806. The Doppler processing unit 806 simply performs an FFT or an IFFT (Inverse FFT) operation over the number of PRI (commonly called Coherent Processing Interval or CPI) over which the RDC1 data is collected.

Referring to FIG. 9, the RDC2 data is then converted into the RDC3 (Radar Data Cube #3) which represents range, Doppler and angle data. This is done using the beamforming unit 901. In one exemplary embodiment, the beamforming unit 901 performs a matrix multiplication using the steering vectors for the desired angles. In another embodiment, the beamforming unit 901 performs a Fast Fourier Transform. As opposed to the final angle estimation performed in the central processing unit 506 in FIG. 5, the beamforming performed in the beamforming unit 901 is based on the virtual receivers available only to a given radar chip. As such, this does not have the range detection or the angular resolution performance of the overall system. The main purpose of performing a beamforming at this stage is to decide the subset (activations) of range/Doppler data in RDC2 that will be forwarded to the central processing unit 506 for final processing. The RDC3 output of the beamforming unit 901 is used in noise floor estimation unit 902. In our exemplary implementation, a per-range histogram is used to estimate the per-range noise floor. For a given range/Doppler, whenever any magnitude across the angle data exceeds the noise floor above a given threshold, that range/Doppler data is “activated,” meaning this range/Doppler belongs to the subset of RDC2 data that will be forwarded to the central processing unit 506. The list 905 represents the activated range/Doppler values that will constitute the valid values in the range/Doppler activation bitmap (705, 706, . . . 708 in FIG. 7). The corresponding RDC2 activations (shown in dark skewers in 906) are then forwarded to the central processing unit 506. They represent the items 701, 706, . . . 708 in FIG. 7. Each sub-system may also forward the estimated noise floor per range 906 as well as the activated RDC3 data 904.

In one exemplary implementation using the Time Domain Multiplexing (TDM) approach with the two virtual antenna array sets (0/1) in the system, illustrated in FIG. 5, the antenna switching occurs at the PRI boundary. Referring to FIGS. 8 and 9, there is no change in RDC1 processing. However, the Doppler processing (processing unit 806 in FIG. 8) and subsequent beamforming, noise estimation, and thresholding operations (processing units 901, 902, 903 in FIG. 9, respectively) are carried out only across PRIs for the same antenna array. The output provided to the central processing unit 506 is then multiple sets of range/Doppler RDC2 activations and the corresponding bitmaps-one per virtual antenna array set within a given CPI.

In another implementation using the TDM approach, the antenna switching occurs at the CPI boundary. In this case, there is no essential change in the processing described in FIGS. 8 and 9. There is a single set of range/Doppler RDC2 activations and its bitmap per CPI. However, the virtual receiver set that this set of activation values belongs to alternates with the CPI.

In another embodiment of the TDM approach, the central processing unit 506 combines the data from the two virtual array sets into a larger virtual array to perform target detection and angle of arrival estimation.

Thus, a MIMO radar system may include a plurality of circuit chips, with each circuit chip configured as a radar chip, and with each radar chip comprising a plurality of transmitters and a plurality of receivers. The MIMO radar system includes a central processing unit configured to receive and process range, Doppler, and virtual receiver data received from at least two radar chips of the plurality of radar chips. In processing the range, Doppler, and virtual receiver data received from the plurality of radar chips, the central processing unit is operable to use the plurality of radar chips to provide for at least one of: virtual receiver scalability, range scalability, range bin scalability, and scalable angle performance.

Changes and modifications in the specifically described embodiments can be carried out without departing from the principles of the present invention which is intended to be limited only by the scope of the appended claims, as interpreted according to the principles of patent law including the doctrine of equivalents.

1. A multiple input, multiple output (MIMO) radar system comprising:
a first plurality of transmitters and a first plurality of receivers arranged on a first circuit chip, wherein the transmitters and receivers of the first circuit chip are configured such that the first circuit chip is operable to perform a first selected receiver processing; and
a second plurality of transmitters and a second plurality of receivers arranged on a second circuit chip, wherein the transmitters and receivers of the second circuit chip are configured such that the second circuit chip is operable to perform a second selected receiver processing;
wherein the first circuit chip is configured to perform the first selected receiver processing independent of the second circuit chip.

2. The MIMO radar system of claim 1, wherein the first circuit chip and the second circuit chip are each separate system-on-chip radar systems.

3. The MIMO radar system of claim 1, wherein the first circuit chip and the second circuit are arranged on separate portions of an integrated circuit chip.

4. The MIMO radar system of claim 1, wherein each of the first selected receiver processing and the second selected receiver processing comprises respective selected range, Doppler, and virtual receiver processing, and wherein the first selected receiver processing is separate from and different from the second selected receiver processing.

5. The MIMO radar system of claim 4 further comprising a processor configured to receive receiver data from at least one of the first circuit chip and the second circuit chip, wherein the processor is configured to control the first circuit chip and the second circuit chip.

6. The MIMO radar system of claim 5, wherein the first circuit chip, the second circuit chip, and the processor are arranged on an integrated circuit chip.

7. The MIMO radar system of claim 5, wherein the processor is operable to control the transmitters and receivers of the first circuit chip and the second circuit chip, such that a selected arrangement of transmitters and/or receivers from the first circuit chip and/or the second circuit chip are used to realize a selected detection range and/or Doppler resolution for a target from the first receiver processing of the first circuit chip and/or the second receiver processing from the second circuit chip.

8. The MIMO radar system of claim 7, wherein the first circuit chip and the second circuit chip comprise a plurality of switches configured to select between receiver antennas such that the first circuit chip and the second circuit chip are each configured to select a respective receiver antenna arrangement, wherein the receiver antennas comprises a first plurality of receive antennas and a second plurality of receive antennas coupled to the first circuit chip and a third plurality of receive antennas and a fourth plurality of receive antennas coupled to the second circuit chip, wherein the first circuit chip is configured to selectively couple the first plurality of receive antennas or the second plurality of receive antennas to the first plurality of receivers, and wherein the second circuit chip is configured to selectively couple the third plurality of receive antennas or the fourth plurality of receive antennas to the second plurality of receivers.

9. The MIMO radar system of claim 5 further comprising an Ethernet network switch configured to communicatively couple the first circuit chip and the second circuit chip to the processor.

10. The MIMO radar system of claim 5, wherein the processor is configured to perform target detection and/or angle estimation for a target based upon selected range, Doppler, and virtual receiver processing from the first circuit chip and/or the second circuit chip, and wherein the processor is a central processing unit.

11. The MIMO radar system of claim 10, wherein the selected range, Doppler, and virtual receiver processing from the first circuit chip and/or the second circuit chip are intermediate processing results, and wherein the processor is configured to perform final processing based upon the intermediate processing results to perform target detection and angle estimation.

12. A multiple input, multiple output (MIMO) radar system comprising:
a plurality of circuit chips, each configured as a separate system-on-chip radar system;
wherein a first circuit chip of the plurality of circuit chips comprises a first plurality of transmitters and a first plurality of receivers arranged on the first circuit chip, wherein the transmitters and receivers of the first circuit chip are such that the first circuit chip is operable to perform selected receiver processing to produce a first set of receiver data;
wherein a second circuit chip of the plurality of circuit chips comprises a second plurality of transmitters and a second plurality of receivers arranged on the second circuit chip, wherein the transmitters and receivers of the second circuit chip are configured such that the second circuit chip is operable to perform selected receiver processing to produce a second set of receiver data; and
a processor configured to receive the first and/or second set of receiver data from the respective first circuit chip and/or second circuit chip;
wherein the first circuit chip is configured to perform the selected receiver processing independent of the second circuit chip.

13. The radar system of claim 12 further comprising an integrated circuit chip, wherein the first circuit chip and the second circuit chip are arranged on the integrated circuit chip.

14. The radar system of claim 13, wherein the first circuit chip, the second circuit chip, and the processor are arranged on the integrated circuit chip.

15. The radar system of claim 12, wherein the processor is configured to control the first circuit chip and the second circuit chip.

16. The radar system of claim 12, wherein the selected receiver processing comprises selected range, Doppler, and virtual receiver processing, and wherein the first circuit chip is configured to perform the selected receiver processing independent of the second circuit chip, and wherein the first set of receiver data is separate from and different from the second set of receiver data.

17. The radar system of claim 16, wherein the first circuit chip is configured to select a subset of range, Doppler, and virtual receiver data produced by the transmitters and receivers of the first circuit chip to produce a first set of selected range, Doppler, and virtual receiver data, wherein the first set of selected range, Doppler, and virtual receiver data comprises a first plurality of range/Doppler selections for a first data bitmap, wherein the second circuit chip is configured to select a subset of range, Doppler, and virtual receiver data produced by the transmitters and receivers of the second circuit chip to produce a second set of selected range, Doppler, and virtual receiver data, and wherein the second set of selected range, Doppler, and virtual receiver data comprises a second plurality of range/Doppler selections for a second data bitmap.

18. The radar system of claim 17, wherein the processor is configured to combine the first and second sets of selected range, Doppler, and virtual receiver data into a combined data set, wherein the processor is configured to perform target detection and angle estimation from the combined data set, and wherein the angle estimation comprises azimuth estimation and elevation estimation for the detected target.

19. The radar system of claim 17, wherein the first and second circuit chips are configured to perform respective selected target detection and angle estimation to produce the first and second sets of selected range, Doppler, and virtual receiver data, and wherein the selected target detection and angle estimation of the first and second circuit chips comprises a lower range detection and/or angular resolution performance as compared to the target detection and angle estimation of the processor.

20. The radar system of claim 17, wherein the first and second circuit chips are configured to generate respective virtual receiver arrays, wherein the processor is configured to generate a combined virtual array comprising the virtual receiver arrays of the first and second circuit chips, and wherein the processor is configured to perform target detection and angle of arrival estimation based upon the combined virtual array.

21. The radar system of claim 17, wherein the processor is configured to use the first and second sets of selected range, Doppler, and virtual receiver data to produce at least one of virtual receiver scalability, range scalability, range bin scalability, and scalable angle performance.
